(19) United States
(12) Patent Application Publication
(10) Pub. No.: US 2011/0030807 A1
(43) Pub. Date: Feb. 10, 2011

(54) FLUID AMPLIFIER

(75) Inventor: Howard Norris, Bethlehem (NZ)

Correspondence Address: KNOBBE MARTENS OLSON & BEAR LLP, 2040 MAIN STREET, FOURTEENTH FLOOR, IRVINE, CA, 92614, US

(73) Assignee: JET STICK LIMITED, Te Puke (NZ)

(21) Appl. No.: 12/438,537

(22) PCT Filed: Aug. 24, 2007
(86) PCT No.: PCT/NZ2007/000229

§ 371 Date: Oct. 27, 2010

(30) Foreign Application Priority Data
Aug. 24, 2006 (NZ) NZ 549455

(51) Int. Cl. F15D 1/02

(52) U.S. Cl. 137/13; 137/602

(57) ABSTRACT

A fluid amplifier which includes a housing, a fluid input into the housing, a fluid output from the housing, the fluid amplifier characterised in that it includes at least one secondary fluid conduit with at least one localised port located within the housing.

### TECHNICAL FIELD

The present invention relates to a fluid amplifier. More specifically the present invention relates to an air amplifier.

In particular this can be used in the labelling industry.

The air amplifier may be used to amplify pressurised air. This air can then be used to apply a label to an item to be labelled.

However, those skilled in the art should realise that the amplifier can be used with a range of machines, not only those used for labelling, and with a range of fluids or gases other than air, and reference to the above industry only throughout this specification should in no way be seen as limiting.

### BACKGROUND ART

In many machines, pressurised air is used to perform a variety of tasks. Sometimes, this pressurised air is amplified to create high volume, high velocity air flows. These air output flows can be produced by an air amplifier, amplifying smaller pressurised air inputs.

Air amplifiers can be used in a variety of machines for tasks such as venting welding smoke, cooling hot parts, drying wet parts, cleaning machines parts and blowing dust off same, distributing heat in ovens, ventilating confined areas, exhausting tank fumes, and applying labels and/or finish to a product.

Standard air amplification modules are made in two threaded pieces which are screwed together. Pressurised air enters through an opening adjacent to the threaded area, and is forced around a gap between the two parts and over an internal lip in the air amplifying module. This gap forces the air to follow the profile of the interior of the module. The air then exits one open end of the air amplification device.

Both ends of the amplifier are open to the atmosphere and thus the pressurised air entering the device creates a vacuum which forces air from the atmosphere through the amplifier. This therefore increases the air flow and velocity, providing an amplified air flow from the original pressurised air input.

However, these common air amplification devices are expensive to engineer as they are usually manufactured from two stainless steel pieces which are precision engineered to screw together and to create the perfect profile for the air to flow over. These devices can therefore be very expensive to produce. Also, as these devices are generally made from steel or another solid metal, they can be heavy and difficult to manoeuvre in a large machine or between desired sites of use.

It would be preferable to have an air amplification device which is light weight and easy to manoeuvre when used in a machine. A change of the angle of air coming out of the air amplification module may be needed in a system, or the air amplification module may need to be lifted away for easy cleaning or maintenance. Therefore, a light weight air amplifier would be preferable to the heavy stainless steel amplifiers currently available.

Also, it would be preferable to have an air amplifier which is cost effective to manufacture. Current air amplifiers can cost hundreds of dollars as they are precision engineered. It would be preferable to find a sturdy material that did not require expensive labour to produce an air amplifier. This would create cheaper machines, as the parts needed would be less expensive. If anything happened to the amplifier it could also be replaced quickly and easily.

It would be preferable to have an air amplifier which includes all of the aforementioned advantages.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a fluid amplifier which includes

a housing,
a fluid input into the housing,
a fluid output from the housing, and
the fluid amplifier characterised in that it includes at least one secondary fluid conduit, with at least one localised port located within the housing.

According to another aspect of the present invention there is provided a method of directing a fluid through a fluid amplifier as substantially described above characterised by the step of
a) introducing a pressurised fluid through a localised port to cause additional flow of fluid through the housing and out the fluid output.

In a preferred embodiment the fluid may be air, and shall be referred to as such herein. Similarly reference herein shall be made to an air amplifier rather than a fluid amplifier. However, this should not be seen as limiting, as one skilled in the art would realise that the present invention may also be used with a variety of other fluids, such as gases other than air (for example modified atmosphere) or liquids.

The present invention provides an air amplifier which may be used for a variety of applications. Preferably, the present invention may be used in the labelling industry as a way of amplifying pressurised air provided to a larger area and a larger velocity than the original pressurised air provided. However, those skilled in the art should recognise that the present invention may be utilised in a range of systems, and reference to its use in labelling only should not be seen as limiting.

Preferably a housing is anything which can act as a conduit for the fluid to the area required to be acted on.

Preferably the housing includes two substantially open ends. These are preferably exposed to the atmosphere. This allows air from the atmosphere to enter the housing freely.

However in alternative embodiments, the housing may be placed or positioned in any other fluid, such as immersed in a liquid, or it may be situated in a gas chamber.

Reference throughout this specification will be made to the housing being exposed to the atmosphere. However, those skilled in the art should realise that the housing may be located in any other fluid and reference to the above only throughout this specification should in no way be seen as limiting.

Having the housing is open to the atmosphere is highly advantageous, so that when the air flows through the device, further air from the atmosphere is forced into the device, thus creating an amplification effect.

Preferably the fluid input and the fluid output are each at a different open end of the housing.

Preferably the housing may be pipe shaped and the fluid input and output may be the open ends of this pipe. Alternatively the housing may be another shape, such as an open ended cuboid, or any other type of open ended geometric prism.

The applicant has found that the amplification effect is decreased if the cross section of the housing is significantly elongated, for example a rectangular shape (say 2:1 ratio) has decreased efficiency due to uneven air flow along the length of the housing.

in a preferred embodiment the housing may have a diameter of between substantially 20 and 75 mm. These are standard pipe sizes, which allows off the shelf components to be utilised, thus significantly decreasing manufacturing costs. However, one skilled in the art would realise that larger or smaller housings may be utilised with the present invention depending on the desired use.

In a preferred embodiment the housing may have a length sufficient to allow the air flow to be homogeneous by the time it reaches the fluid outlet. This is highly desirable in some uses, for example when the amplifier is used in a labelling application. A homogeneous air flow at the outlet ensures that labels can be directed in a straight line and positioned accurately on the item to be labelled.

In a preferred embodiment the length of the housing may be at least 120 mm. The applicants have found that this is the minimum length to provide a homogeneous air outflow.

However, one skilled in the art would readily realise that a homogeneous air flow at the outlet may not be required for many applications. In these cases, the housing may have a length of less than 120 mm and still provide efficient amplification.

In one preferred embodiment, the housing may be a substantially rectangular cuboid shape. This is advantageous in that it allows multiple air amplifiers to be lined up adjacent to one another in a row with minimal space wastage. In the labelling industry, this can allow multiple air amplifiers to blow labels onto many items at one time, such as a tray of fruit being labelled all at the same time. This avoids the tray having to move on a conveyor through the labelling machine to achieve the same multiple labelling action, and can aid the efficiency of the machine.

Preferably the housing may be made of a rigid plastic. This decreases both the weight and cost of the housing, and allows quick and easy manufacture. This also means it will retain its shape when in use. However, in alternative embodiments the housing may be made of steel, ceramic, or any other sturdy material which will hold its shape when pressurised fluid is applied into, and flows through it.

Reference throughout the specification will be made to a housing being plastic. However, those skilled in the art should realise that other materials are available and reference to the above only throughout this specification should in no way be seen as limiting.

Preferably the secondary fluid conduit may be in the form of an input pipe into the housing.

Preferably the secondary fluid conduit may enter the housing at an angle of substantially 90 degrees. However, this should not be seen as limiting as one skilled in the art would realise that the secondary fluid conduit could also enter the housing at alternative angles.

In a preferred embodiment the secondary fluid conduit may extend to substantially the centre of the housing. This positions the localised port in substantially the centre of the housing.

In a preferred embodiment the housing may include only one secondary fluid conduit.

In a preferred embodiment the single secondary fluid conduit may be positioned at substantially one end of the housing. In this instance, the end of the housing where the secondary fluid conduit and associated localised port is positioned would be the fluid inlet, and the opposing end would be the fluid outlet. The localised port would be positioned such that fluid is directed along the length of the housing, towards and out the fluid outlet.

In an alternative embodiment the housing may include two secondary fluid conduits.

In a preferred embodiment the housing includes two secondary fluid conduits when it is desirable to be able to change the fluid input to the fluid output and vice versa.

In a preferred embodiment when the housing includes two secondary fluid conduits, these are positioned at substantially opposite ends of the housing, with each associated localised port facing along the length of the housing towards the fluid outlet at the opposing end.

Preferably the fluid input may also act as a fluid output, and vice versa. In this situation the open ends of the housing defining the fluid input and fluid output are determined by the direction of fluid flow from a secondary fluid conduit into the housing through a localised port.

In a preferred embodiment the amplifier may also include a means of controlling which secondary fluid conduit and associated localised port(s) is active (releasing pressurised air into the housing). The means of controlling this may be via any method known to one skilled in the art.

Preferably, the secondary fluid conduit may be connected to a pressurised air source, and shall be referred to as such herein.

In use, the pressurised air source provides pressurised air through the secondary fluid conduit which flows out the localised port and into the main housing to create an amplification effect for the air amplifier device. However, in alternative embodiments, the secondary fluid conduit may provide any other fluid being amplified to the housing.

Reference throughout the specification will be made to the secondary fluid conduit being connected to a pressurised air source. However, those skilled in the art should realise that other fluids can be used, and reference to the above only throughout this specification should in no way be seen as limiting.

The pressurised air source to which the secondary fluid conduit may be connected may be any known devices or air compression units. These are well known to those skilled in the art. One skilled in the art would realise that if a fluid other than air is to be amplified, then any known device or compression units for that fluid may be utilised with the present invention.

In one preferred embodiment the pressurised air flowing through the secondary fluid conduit and out the localised port may be within the range of 0.1 to 4 bar. However, one skilled in the art would realise that a range of other air pressures could be utilised with the present invention depending on the desired amplification effect, and size of the fluid amplifier.

The applicant has found that it is not necessary to increase the pressure of the fluid released through the localised port in the secondary fluid conduit as the size of the housing increases. This is due to the same per area amplification effect observed.

In a preferred embodiment each secondary fluid conduit may have one localised port, and shall be referred to as such herein. However, this should not be seen as limiting as one skilled in the art would realise that multiple localised ports could be positioned on a single secondary fluid conduit.

Preferably the localised port has a defined shape. Preferably this localised port is the form of a slot.

In a preferred embodiment the slot may be a rectangular shape with two parallel side walls substantially longer than two parallel end walls. This shape allows the fluid passing through the pressurised fluid conduit to fan out and thus hit the interior walls of the housing quickly.

However, one skilled in the art would realise that the slot could also be a wide number of other shapes. This will depend on the desired flow of pressurised fluid into and through the housing.

In alternative embodiments, the localised port may be a port or hole of any shape. The slot shape is preferred as it provides a greater amplification effect as the air is forced out at larger angles than if the localised port was a perfectly circular hole, but for some purposes, a hole of another shape may be preferable.

Reference throughout the specification will be made to a localised port being a slot. However, those skilled in the art should realise that other shapes of port are available and reference to the above only throughout this specification should in no way be seen as limiting.

Preferably the localised port may be a shape which allows the air flowing out of the port to hit the interior walls of the housing at the same time to provide a consistent and efficient amplification effect.

The localised port is located within the housing.

Preferably the localised port is provided substantially equidistant from the side interior walls of the housing. This is preferred as the air forced through the localised port is equally far from the opposing interior walls of the housing and therefore hits the walls at the same time, creating the most efficient amplifier. However, in alternative embodiments the localised port may be closer to one interior side wall of the housing than any other wall.

As pressurised air is forced through the localised port of the present invention, it fans out from the port in the centre of the housing and is directed onto the interior side walls of the housing. The air is forced out the fluid outlet at a high velocity, resulting in the atmospheric air inside the housing also being moved and forced to flow. As air exits the housing through the fluid outlet, more air is drawn into the housing from the atmosphere through the fluid input thus creating a high velocity outflow exiting the fluid output and an amplification effect.

The applicant has found that the shape of the localised port/slot when in a rectangular form affects the amplification effect observed. The amplification effect was observed to increase with increasing length of the slot around the circumference of secondary fluid conduit when the secondary fluid conduit is in the form of a pipe. The amplification effect was observed to increase with the length of the slot until this had an opening of 120 degrees of the circumference of the pipe, i.e. releasing pressurised air through a radius of 120 degrees. After this the amplification effect was observed to decrease. This was found utilising a secondary fluid conduit pipe of 6 mm in diameter, with the slot being 1 mm wide.

Preferably at least one open end of the housing (acting as the fluid input or fluid output) may include a grille.

In one embodiment the grille may be positioned on the fluid input only. However, in instances where the fluid inflow and outflow can be switched between it should be appreciated that a grille on both open ends of the housing may be preferred.

Throughout this specification the term grille should be taken to include a plurality of bars extending across the diameter of the open end(s) of the housing in either one, two or more directions.

In one preferred embodiment the grille may include a plurality of bars extending across the diameter of the open ends of the housing in one direction, and shall be referred to as such herein.

One skilled in the art would readily realise that the number and configuration of bars making up the grille can differ substantially depending on the desired effect—in both minimising the pick up of debris and minimising the restriction of air flow through the grille.

In one preferred embodiment the grille may be made up of at least four bars positioned in one direction across the open end(s) of the housing.

In one embodiment the grille may partially cover the open end(s) of the housing.

In a particularly preferred embodiment the grille may extend across substantially the whole open ends of the housing. This means that when air is sucked in through the fluid input, or output, no debris or other article is sucked in as well. This is useful when using the present invention to detach adhesive labels from a backing material, as the grille prevents the label from being sucked into the housing, and possibly blocking the localised port.

In a preferred embodiment the grille may cover between substantially 0 and 40% of the open ends of the housing. It should be appreciated that the greater the coverage of the grille the greater the restriction to air flow through the open end of the housing. Therefore there is a trade off between minimising debris entering the housing in the fluid inflow and restricting air flow through the housing. It should be appreciated that in many instances a grille may not be utilised with the present invention, thus providing for maximum air flow through the amplifier.

In one preferred embodiment the grille may cover substantially 5% of the open end(s) of the housing. However, one skilled in the art would realise that this is not limiting and a wide range of different coverage could be utilised with the present invention.

The present invention provides a simple, lightweight air amplifier. The air amplifier provided can be any shape or size and made out of any material. This means rectangular air amplifiers can be made out of a rigid plastic material. This shape and material means that many air amplifiers can be lined up in a row and maneuvered easily.

The air can flow in or out of either end, providing flexibility for the system not seen in the prior art. This is accomplished by the housing incorporating two secondary fluid conduits with associated localised ports positioned at substantially either end of the housing, with the localised ports facing along the length of the housing and towards the opposing end from that at which it is located.

Having a changeable inflow and outflow from the amplifier is beneficial in many situations, for example when the amplifier is used in or in conjunction with a machine that uses air amplification for labelling. Being able to change the air flow direction without moving the air amplifier means that a label can be peeled off its backing adhesive, with the suction preventing the label from falling from the apparatus and then blown onto a product. A secondary advantage of this feature is that combined with a rectangular shape of the housing this allows many labels to be applied at the same time. This means a tray of fruit could be labelled all at the same time.

One example of the amplifier of the present invention being used in a labelling situation is that applicant's JIA industrial Applicator (www.jetstick.co.nz). This utilises a double acting amplifier (where the fluid input and output can be selected). The label is dispensed by a thermal printer (or other label provider) onto the face of the amplifier where it is held by suction. The amplifier (and label) are then moved to the labelling position where the suction is released and the air flow through the amplifier is reversed, i.e. the input becomes the output and vice versa. This provides an amplified air flow which propels the label onto the target surface.

In a preferred embodiment the amplifier (applicator) also includes an adaptor which allows change between the labels being applied from a vertical position and one at 90 degrees.

In a preferred embodiment the amplifier may be attached to the thermal printer by way of attachment to the base plate of the printer. This may include multiple interfaces, including for example, RS232, with secondary interfaces being 24V logic and IIC.

The benefits of utilising the amplifier of the present invention in labelling processes include the following:
there is no contact with the item being labelled, thus minimising product damage;
the amplifier is able to propel labels for approximately 100 mm;
it is inexpensive and accurate;
it can apply labels to irregular surfaces;
it can apply labels to variably shaped packages;
it is robust and low maintenance;
it is high speed, being able to operate at approximately one label per second;
it is adaptable, being able to propel labels at either a 90 degree angle or vertically.

The applicant has found that the amplifier of the present invention should preferably be over 120 mm in length in order to be efficient in a label application. This length is sufficient to allow the air flow to homogenise. This is independent of the bore (width across the housing in a parallel manner to the fluid input and/or fluid output.

The present invention provides a substantial improvement over the prior art, and provides a number of significant advantages, including the following:
The amplifier of the present invention is cheap and easy to manufacture due to the ability to utilise cheaper and easier to handle materials, such as plastic,
Due to the materials utilised to manufacture the amplifier, this is lightweight, particularly when compared to the current threaded air amplification modules, which are heavy and expensive, due to the need to precision engineer multiple parts,
The use of a secondary fluid conduit with a localised port within the housing simplifies the design while providing efficient amplification, this significantly decreases the complexity and precision required to manufacture, set up or maintain the amplifier,
The amplifier of the present invention may be manufactured in a variety of shapes and sizes depending on the use to which it is to be put. Again, this simplifies the equipment required.

### BRIEF DESCRIPTION OF DRAWINGS

Further aspects of the present invention will become apparent from the following description which is given by way of example only and with reference to the accompanying drawings in which:

FIG. 1 shows a side view of the amplifier of the present invention with one secondary fluid conduit and associated localised port, and

FIG. 2 shows a side view of the amplifier of the present invention with two secondary fluid conduits and associated localised ports.

### BEST MODES FOR CARRYING OUT THE INVENTION

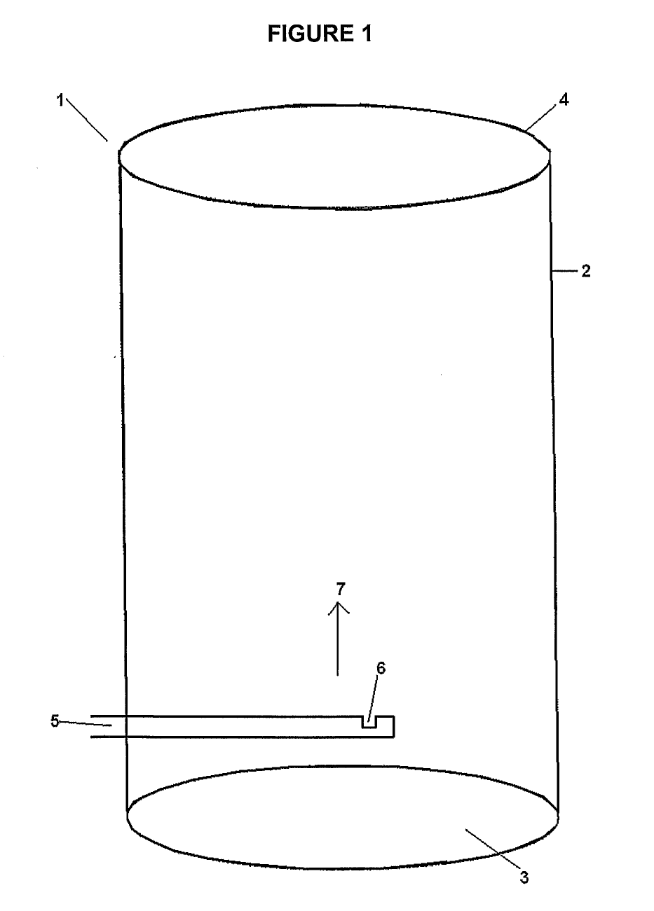

FIG. 1 shows an air amplifier (generally indicated by 1).

The amplifier (1) includes a housing (2), which includes a fluid input (3), and a fluid output (4). The amplifier also includes a single secondary fluid conduit (5), formed as an air input pipe, which includes a localised port (6), shaped as a slot, located within the housing, at substantially the centre of the housing, such that the localised port is substantially the same distance from opposing side walls of the housing.

Pressurised air enters the housing (2) through the air input pipe (5) and out the slot (6), in the direction indicated by arrow (7). It then fans out and hits the interior walls of the housing (2). The air follows the interior walls of the housing to the fluid outlet. This creates a low relative pressure from the outside atmosphere. Air from the atmosphere is then forced through the fluid input (3) into and through the housing and out the fluid outlet.

The air flowing out the fluid output (4) is therefore at a larger velocity and surface area than the initial air provided from the secondary conduit (5).

The air amplifier housing provided is preferably formed from substantially one piece. This housing can be formed from a curved shape such as is seen in FIG. 1, but can also be formed as a rectangular cuboid. Having a rectangular cuboid shaped housing allows multiple air amplifiers to be lined up together in a minimum of space.

The amplifier as shown in FIG. 1, with a single secondary fluid conduit and associated localised port is utilised when a change in flow direction, and thus a change in the fluid input and output is not desired.

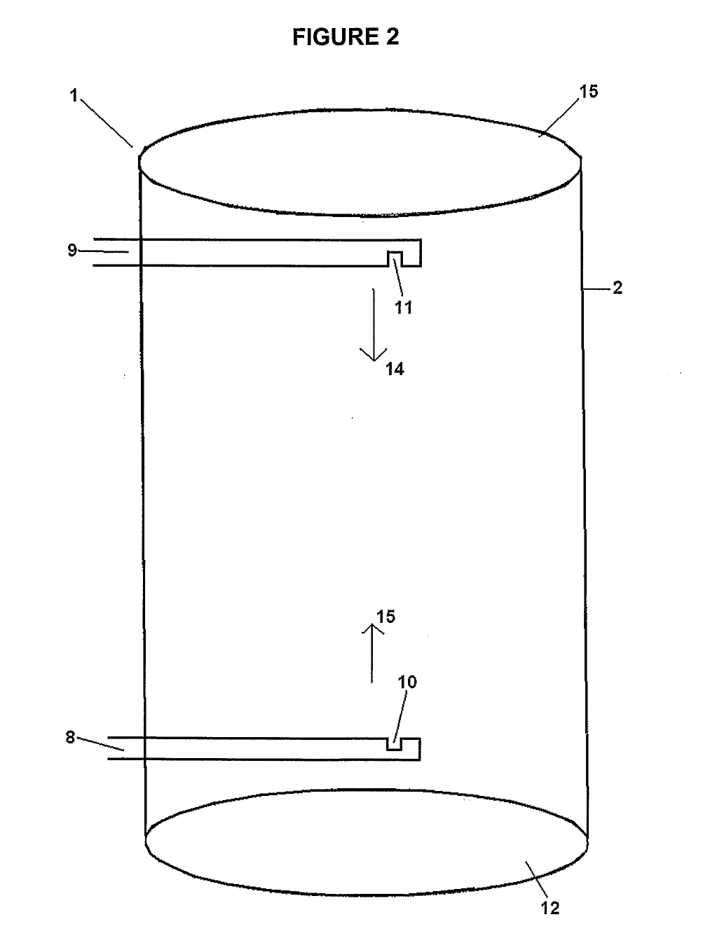

When it is desired to be able to change the fluid flow through the housing, so that the fluid input and output can be alternated or changed, the housing includes two secondary fluid conduits and associated localised ports, as shown in FIG. 2.

FIG. 2 shows two secondary fluid conduits (8, 9) and associated localised ports (10, 11).

When open end (13) of the housing is to be the fluid output, pressurised air enters the housing through secondary fluid conduit (9) and port (11), in the direction indicated by arrow (14). When open end (14) of the housing is to be the fluid output, pressurised air enters the housing through secondary fluid conduit (8) and port (10), in the direction indicated by arrow (15). This allows the direction of flow through the housing to be easily and quickly altered by controlling which secondary fluid conduit and localised port pressurised air enters the housing through.

The amplifier as shown in FIG. 2 may be used for example in the applicants JIA Industrial Applicator (www.jetstick.co.nz) as described in the disclosure section.

One skilled in the art will realise that control of which open end of the housing acts as the inflow or outflow may occur by only one of the secondary fluid conduits and associated localised ports being active (releasing pressurise air) at a time. Therefore the amplifier may also include a means of controlling which secondary fluid conduit and associated localised ports is active.

The air amplifier provided is a cheaper alternative to previous air amplifiers that requires no precision engineering and which may be formed in a variety of shapes, sizes and materials.

Testing was undertaken to compare an amplifier of the present invention with an existing amplifier.

The amplifier of the present invention utilised a 6 mm pipe as the secondary fluid conduit, the localised port was formed in the pipe as a rectangular slot 1 mm wide and with a length covering 120 degrees of the circumference.

The existing amplifier was a standard ExAir amplifier with two threaded pieces screwed together, as discussed in the background art section. This was optimised for maximum flow.

Two sizes of each amplifier were tested, being 30 mm and 100 mm in height respectively.

Only minimal testing was undertaken due to limited equipment available and the availability of only low flow rate meters. Scales were used to give an indication of comparative force produced by the air stream exiting the housing through the fluid output.

For a flow rate of 45 litres/minute (inflow through localised port): The amplifier of the present invention produced 13 grams, whereas the existing amplifier only 4 grams.

This shows that the amplifier of the present invention can produce results which are significantly better than obtainable for existing amplifiers.

In a second test the amplifiers were compared utilising an input of 4 bar air pressure (the flow rate for this test was unknown). The amplifier of the present invention produced 90 grams and the existing amplifier 130 grams.

It is believed by the applicant that the flow through the amplifier of the present invention was restricted at this air pressure due to the significantly smaller inflow of pressurised air through the localised port (size 1 mm by 140 degrees of circumference of a 6 mm secondary fluid conduit pipe) as compared to the inflow of pressurised air through the concentric orifice of the existing amplifier.

Another significant advantage of the amplifier of the present invention is that when the weights of the present and existing amplifiers were compared (for the 100 mm size) the amplifier of the present invention weighed only 10% that of the existing amplifier.

Aspects of the present invention have been described by way of example only and it should be appreciated that modifications and additions may be made thereto without departing from the scope of the appended claims.

1. A fluid amplifier which includes:
a housing,
a fluid input into the housing,
a fluid output from the housing,
at least one secondary fluid conduit in the form of an inlet pipe which extends into the interior of the housing, wherein the secondary fluid conduit includes at least one localised port in the form of a slot,
wherein the slot has two substantially parallel side walls substantially longer than two substantially parallel end walls.

2. A fluid amplifier as claimed in claim 1 wherein the housing is substantially open at two ends.

3. A fluid amplifier as claimed in claim 2 wherein the fluid input and the fluid output are each at a different open end of the housing.

4. A fluid amplifier as claimed claim 1 wherein the fluid is air.

5. A fluid amplifier as claimed in claim 1 wherein the housing is substantially pipe shaped.

6. A fluid amplifier as claimed in claim 1 wherein the housing is substantially a rectangular cuboid shape.

7. A fluid amplifier as claimed in claim 1 wherein the housing is manufactured out of rigid plastic.

8. (canceled)

9. (canceled)

10. (canceled)

11. (canceled)

12. A fluid amplifier as claimed claim 1 wherein the localised port is substantially equidistance from opposing interior side walls of the housing.

13. A fluid amplifier as claimed in claim 1 wherein at least one open end of the housing includes a grille.

14. (canceled)

15. A fluid amplifier as claimed in claim 1 wherein the two secondary fluid conduits are positioned at substantially opposite ends of the housing.

16. A fluid amplifier as claimed in claim 15 wherein the localised port of each secondary fluid conduit is positioned facing the opposite end of the housing.

17. A fluid amplifier as claimed in claim 15 wherein the amplifier includes a means of controlling which secondary fluid conduit and associated localised port is activated.

18. A method of directing a fluid through the fluid amplifier as claimed in claim 1, the method comprising
a) introducing a pressurised fluid through a localised port to cause additional flow of fluid through the housing and out the fluid output.

19. (canceled)

20. (canceled)

21. A fluid amplifier as claimed in claim 1 wherein the slot extends substantially in an arc around the circumference of the inlet pipe, the arc not extending substantially beyond 120° of the circumference of the inlet pipe.
